(19) United States
(12) Patent Application Publication
(10) Pub. No.: US 2007/0019912 A1
(43) Pub. Date: Jan. 25, 2007

(54) Illuminateur laser

(75) Inventor: Yves Lutz, Hesingue (FR)

Correspondence Address: OLIFF & BERRIDGE, PLC, P.O. BOX 19928, ALEXANDRIA, VA, 22320, US

(73) Assignee: INSTITUT FRANCO-ALLEMAND DE RECHERCHES DE SAINT-LOUIS

(21) Appl. No.: 11/402,872

(22) Filed: Apr. 13, 2006

(30) Foreign Application Priority Data
Apr. 14, 2005 (FR) 05 03718

(51) Int. Cl. G02B 6/26

(52) U.S. Cl. 385/43; 385/146

(57) ABSTRACT

In the field of devices employing stimulated emission, a long-range laser illuminator may include a matrix of high-brightness infrared emitters. Each emitter is able to emit a first beam. The illuminator may be able to process the first beams coming from emitters disposed opposite and in the vicinity of the matrix. The illuminator may also be able to assemble the beams into a second unique, homogenous beam. The illuminator may include a prism including a planar input face disposed opposite the emitter matrix and a planar output face, the latter being disposed opposite a collimation lens.

This Application claims priority from French Patent Application No. FR 05 03718, filed Apr. 14, 2005 the disclosure of which is incorporated by reference thereto.

### BACKGROUND

The present invention relates in particular to the field of devices employing stimulated emission and in particular to a laser illuminator using a matrix of high-brightness laser diodes.

The use of laser illuminators has become very widespread since the general advent of semiconductor lasers. Applications include night vision in which laser illuminators are used as a long-range artificial lighting source, typically over a range of 1 to 10 kilometers.

To record images in a scene containing objects moving rapidly and over long distances under very-low-light conditions, for example at night, it is essential to add a specific lighting source to the viewer, which is generally comprised of optics and a camera. The particular characteristics of this source are: directivity, high peak power, and wavelength centered on the maximum sensitivity of the detector used. The laser has these properties, and of the various types of laser sources the semiconductor laser or diode laser appears best suited from the standpoint of its excellent optical/electrical efficiency, performance, compactness, and cost. The fact that this type of source requires no cavity adjustment makes it particularly suited for use in an outdoor environment, particularly one involving vibration and impacts. To provide sufficient lighting power, use is made of components with multiple emitters arranged (as shown in FIG. 1) in a matrix 2 with one or two dimensions for the emitting surface and where each emitter is comprised of a laser. The total power of the component is then obtained by adding the powers of each emitter. However, a semiconductor laser source is characterized by very particular beam properties. A laser emitter (1) has an asymmetric beam divergence in two perpendicular directions called fast Y axis and slow X axis, as shown in FIG. 1. More generally, the divergence, for a laser diode 1, is approximately 10° along an axis parallel to the junction, the X axis in FIG. 1, and approximately 40° along an axis perpendicular to the junction, namely the Y axis.

In the case of laser diode matrices, whether in one or two dimensions, each emitter emits a unitary beam with an asymmetric divergence resulting in a global envelope that is also asymmetric. Such beam characteristics are not compatible with scene illumination applications in which the goal is to achieve homogeneous illumination with no hot spots and whose divergence is controlled. Moreover, to obtain a usable laser beam, i.e. with low divergence symmetrical in both axes, it is necessary to collimate the matrix beams.

Also, if higher lighting power is desired for a given laser diode matrix, the size of the emitter matrix can be increased, or the density of the emitters on the emitting surface can be increased.

The first method has the major drawback of excessively increasing the size of the total emitting surface. Thus, the component loses its compactness and rigidity. Moreover, the brightness of the source is reduced, which has a direct effect on the sizing of the beam processing optics.

A second method consists of increasing the density of the emitters on the matrix. This increases the brightness of the source and the compactness of the component. Such components exist on the market under the name of high-brightness matrix or stack. In such components there are up to a thousand emitters or lasers on a surface of 10×1.5 mm. This increased density has two drawbacks, however, namely: greater difficulty in cooling and greater difficulty in collimation. Cooling has a direct effect on the average power or repetition rate which will be less than in the case of classical matrices. A high-brightness matrix, however, allows one to work with high peak powers and at a higher repetition rate than the video rate (25 Hz). A higher emitter density affects beam collimation. The distance between the emitters in a classical matrix allows each emitter to be associated with its own microlens or microfiber. In the case of high-brightness matrices, the emitter density makes these collimation techniques unusable.

U.S. Pat. No. 5,825,803 describes the use of lenses made of fibers with a gradual variation in the index of refraction, the lengthwise axis of the fiber being perpendicular to the light source. In this way, collimation of a row of matrix emitters is achieved. A second collimation device must be provided to handle the matrix columns.

Manufacturing such a lens is complex and the slightest quality or alignment flaw causes a collimation defect.

French Patent Application No. FR0212572 published under publication number FR2816776 is also known, and describes a collimation device with a high-brightness matrix having a plurality of point sources and characterized by having at least one optical fiber whose first end is disposed near and opposite the sources, the numerical aperture of the optical fiber end being greater than the numerical aperture of the sources. However, for a large high-brightness matrix, several optical fibers are necessary and, at the output, several beams are obtained which have to be recombined one at a time to preserve lighting homogeneity.

U.S. Pat. No. 4,688,884 is known and describes a technique for collimating several emitters arranged in a row and consisting of a single glass fiber whose end is squashed and adapted to the emitter row. The fiber is stretched in the direction of the row and compressed in the direction perpendicular to the row. The sole purpose of squashing the fiber at the input is to geometrically adapt the fiber input to the row geometry to optimize coupling of the light. This operation does not change the area of the fiber surfaces. The output beam angle is determined by the numerical aperture of the fiber and is identical in the two perpendicular planes. Thus, one goes from a beam with different divergences at the emitter row output to a beam with equal divergences at the fiber output (greater than or equal to the greatest row divergence) so that the benefit of low divergence along the axis of the row is lost. In view of the section of the input and output areas of the fiber and the residual divergences, there is an unfavorable loss of brightness. Finally, at the output, the beam is in the shape of the optical fiber core, or circular. But viewing devices used with laser illuminators have a detector with rectangular geometry whose width to height ratio is usually 4:3 and, to achieve the highest possible detection efficiency of the night-viewing system, it is necessary to have an illumination beam in the same shape, which is not possible at the output of an optical fiber without squashing it. Moreover, the divergence angle of the beam at the fiber output cannot be chosen as a function of geometric parameters but only as a function of the numerical aperture of the fiber and hence of the refraction indexes of its core and its envelope.

U.S. Pat. No. 6,272,269 is also known and describes an illumination system in the visible range by optical fiber which may have an array of LEDs (light emitting diodes) or visible laser diodes each able to emit a first beam, an optical fiber, means for collecting, concentrating, and homogenizing the first beams, and a second single and homogeneous beam, and means for coupling the second beam to the optical fiber.

Such a system has several drawbacks, namely:

at the output of the optical fiber, the beam cannot have a rectangular shape unless it is squashed,

the divergence angle of the beam at the fiber output cannot be chosen as a function of geometric parameters but only as a function of the numerical aperture of the fiber and hence of the refraction indexes of its core and its envelope.

U.S. Pat. No. 5,307,430 is also known and describes means for collecting and concentrating the first beams emitted by a diode matrix into a single second beam designed to pump a laser crystal abutting the means. The latter are comprised of a substantially prismatic light guide whose section opposite the diode matrix is convex. This convexity enables the intensity of the second beam to be increased but increases its divergence, which dims its brightness. However, since the crystal abuts the means, the increase in divergence angle has no effect on the use of the beam but the situation inside a laser illuminator is quite different.

### SUMMARY

A goal of the invention is to propose an illuminator using a high-brightness laser diode matrix which is highly compact, simple both in manufacture and in implementation, and able to process beams emerging from a high-brightness matrix in two axes simultaneously enabling a fully homogeneous single beam to be obtained, that corresponds to an illumination beam with increased brightness by comparison with existing devices and whose final lighting angle can be readily determined geometrically.

The solution provided is a long-range laser illuminator having a matrix of high-brightness emitters in the infrared, each able to emit a first beam, and means able to process the beams coming from the emitters disposed opposite and in the vicinity of the matrix and able to assemble the first beams into a second unique, homogenous beam, characterized in that the means are comprised of a prism having a planar input face disposed opposite the emitter matrix and a planar output face, the latter being disposed opposite collimation means, for example a collimation lens. In the following text, this prism will also be called a light conduit.

“Proximity” is understood as a distance between for example 0.05 and 1 mm and the matrix can have any shape such as, for example, square or rectangular.

According to one additional feature, the width-to-height ratio of the output planar face of the prism is approximately 4:3, namely between 1.2 and 1.5.

According to one particular feature, the means for processing the first beams have an axis of symmetry and are delimited by a first surface disposed opposite and in the vicinity of the matrix, a second surface from which the second beam exits, and four lateral surfaces connecting the first and second surfaces, and two of the lateral surfaces form an angle a of less than 15° with the axis of symmetry.

According to an additional feature, the beams coming from the emitters are divergent along two axes X and Y, called fast axis and slow axis, respectively, these axes being perpendicular to the axes of the beams, and the lateral surfaces that are able to reflect the beams along the slow axis form an angle a with an axis Z perpendicular to the fast and slow axes such that, over the entire length of the prism, the angle of incidence of the first beams, along the slow axis relative to the perpendicular to the lateral surfaces, is greater than the total reflection limit angle.

According to one particular feature, the emitters of the matrix are comprised of laser diodes.

According to an additional feature, the prism is made of glass or PLEXIGLAS.

According to an additional feature, the prism is hollow and its faces are reflective.

According to another feature, the first surface is covered with an antireflection coating.

### BRIEF DESCRIPTION OF THE DRAWINGS

The patent or application file contains at least one drawing executed in color. Copies of this patent or patent application publication with color drawings will be provided by the Office upon request and payment of the necessary fee.

Other advantages and characteristics will emerge from the description of a particular embodiment of the invention with reference to the attached drawings wherein:

FIG. 1 shows a one-dimensional high-brightness diode matrix;

FIG. 2 shows schematically a laser illuminator according to one particular embodiment of the invention;

FIG. 3 illustrates propagation of the first beams emerging from the high-brightness matrix in the major divergence direction, namely along the fast axis;

FIGS. 4a and 4b show two examples of beam propagation emerging from the high-brightness matrix in the low divergence direction, namely along the slow axis;

FIGS. 5a and 5b show, in two dimensions and three dimensions respectively, the profile of the output laser beam emerging from the beam assembly means;

FIG. 6 shows a night scene illumination example with an illuminator according to the invention.

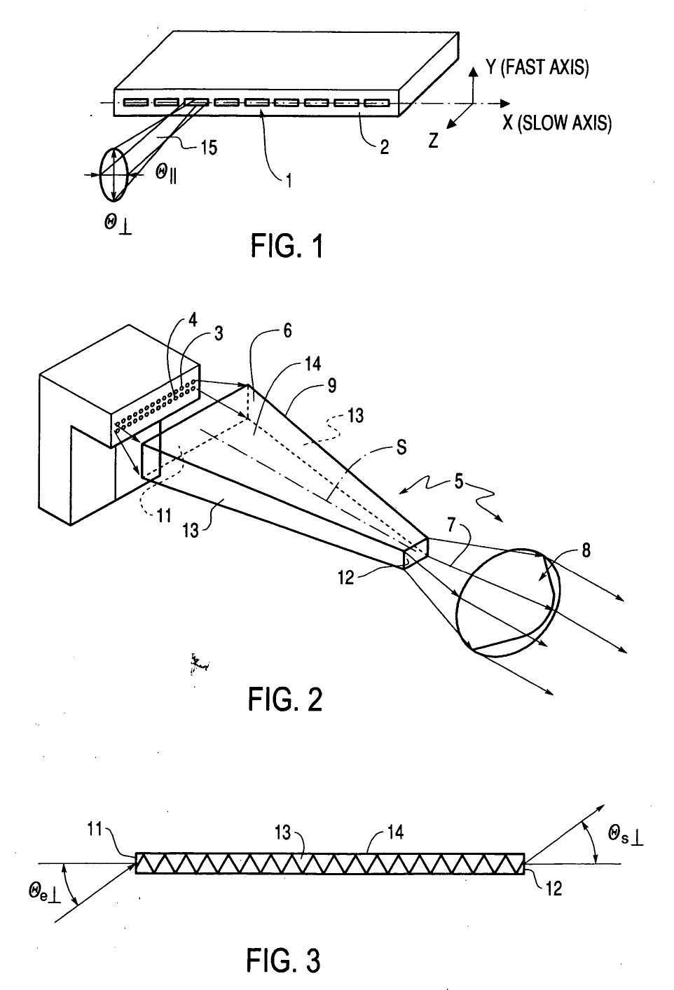

### DETAILED DESCRIPTION OF EMBODIMENTS

FIG. 2 shows a laser illuminator according to the invention. It has a two-dimensional matrix 3, high-brightness laser emitters 4, each emitter emitting a first beam 15, means 5 for processing the first beams from the laser emitters and collimating them, the means 5 having first means 6 disposed opposite and in the vicinity of matrix 3 and able to assemble the first beams 15 into a second unique, homogenous beam 7 and to shape the latter. The means 5 for processing the first beams 15 additionally has a second means 8 able to collimate this second beam 7. The shape of the output surface of the first means 6 able to assemble the first beams 15 into a second single beam 7 is preferably optimized to enable the second means 8, able to collimate this second beam 7, to produce perfect superimposition between the zone illuminated by the illuminator and the field of view of the imaging system associated with the illuminator.

The matrix 3 is composed of 900 laser emitting sources 4 such as laser diodes for example. The dimensions of the overall emission surface are 1.4×9.6 mm. This emitting surface can be considered as a point source and has a divergence of 10° along an axis parallel to the junction, namely the X axis, usually called the slow axis, and a divergence of 40° along an axis perpendicular to the junction, namely the Y axis, this axis usually being called the fast axis.

The envelope of the beam emerging from this emitting surface is comprised of the sum of the unit beams 15 from each emitter.

The first means 6 disposed opposite and in the vicinity of matrix 4 and able to homogenize and format the first beams into a second unique homogeneous beam 7 are comprised of a light conduit 9 made of a material transparent to the emission wavelength of the diodes 4, such as glass or PLEXIGLAS for example. This conduit is in the shape of a full prism delimited by:

a first planar surface 11 disposed opposite the matrix and through which the beams coming from the various diodes 4 of matrix 3 enter. Its dimensions are equal to those of the emitting surface of the laser diode matrix plus an additional thickness enabling all the rays from the diode matrix 4 to be combined in the light conduit 9;

a second surface 12 with a smaller section than the first surface and from which emerges a single, homogeneous beam 7;

lateral planar surfaces connecting the first surface 11 to the second surface 12, namely two lateral surfaces 13 with a rectangular section and disposed along the fast Y axis and two lateral surfaces 14 with a trapezoid section disposed along the slow axis X. Each of the edges formed by the junction of two adjacent lateral surfaces 13 and 14 makes an angle a with the Z axis perpendicular to the X and Y axes.

At the output from light conduit 9 are disposed the second means 8 able to collimate beam 7 and comprised of a collimating lens 8 for projecting the image from the output surface of the conduit onto the scene to be illuminated.

The geometric shape of the second beam 7 is determined by the shape of the output surface 12 of the light conduit 9. The latter enables the second beam 7 to be shaped. Preferably, this shape is adapted to the shape of the image sensor used in association with the laser illuminator. In a classical system employing a CCD camera, the ratio between the width and height of the detector is 4:3. Also, to optimize illumination, it is preferable to use the same width-to-height ratio for the output surface 12 of the light conduit 9. Once this ratio is established, one need only determine the value of one of the sides of the output surface, so that the other can be deduced.

If a plate with parallel faces is used and the goal is to analyze the propagation of the rays of the first beams in the direction corresponding to the greatest divergence (40°), one can see, as shown in FIG. 3, that all the rays except those corresponding to reflection losses over the input surface 11 are coupled in conduit 9 and propagate according to the law of total reflection. The output angle of the beam in this direction is equal to the injection angle θ_{e⊥} and θ_{s⊥}. θ_{e⊥} denotes θ_{incident} according to the fast Y axis and θ_{s⊥} denotes θₑₓᵢₜ according to the fast Y axis.

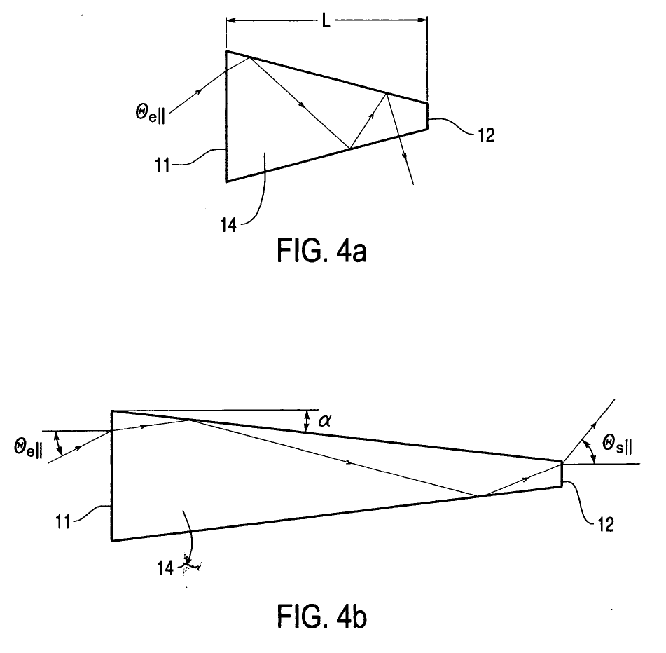

FIGS. 4a and 4b show the propagation of the rays of the first beams in the direction corresponding to the smallest divergence (10°) in the light conduit 9. From FIG. 4a we see that, upon propagation, the angle of incidence of the rays to the line perpendicular to the lateral surface decreases until it is less than the critical angle of total reflection. After this point, the rays leave the light conduit 9 via its lateral surfaces 13 rather than via the second surface 12, thus generating losses incompatible with achieving good energy efficiency. This case in point occurs when the angle a, previously defined, is too large. The width of the input surface 11 of conduit 9 is fixed by the width of matrix 3, so that the angle a is governed both by the output dimension height H and by the length L of the conduit; hence these two parameters must be optimized to achieve the best possible efficiency, avoiding such losses.

Moreover, the compactness of the laser illuminator assembly is related to its brightness B [W m⁻² sr⁻¹] by the equation:
B=P/(AΩ)
where P represents the power emitted by the beam with section A at the output of the laser illuminator and Ω represents the beam divergence solid angle. The overall brightness of the laser illuminator cannot in any case be greater than the brightness of the basic component, namely the diode matrix. The optical elements 8 and 9 in the path of the beam, if they are perfect, necessarily preserve the brightness of the starting laser source. The light conduit is called “perfect” if it reproduces the input brightness at the output. If the conduit absorbs no power or has no lost rays as illustrated in FIG. 4a, the output power is identical to the input power. Thus, the parameter to be optimized is the product of area A of the beam leaving the illuminator and the solid divergence angle Ω of the same beam.

The divergence angle Ω of the laser illuminator is generally fixed by the application and the goal is to illuminate a scene of a given size at a given distance. The value of the focal length ƒ of lens 8 is deduced from the following equation:
ƒω/δ
where ω is the dimension, in the given direction, of the beam leaving the conduit, δ is the divergence angle of the beam brought into one plane.

Since the illuminator is not axially symmetrical, the following reasoning must be used along the two perpendicular axes.

We can see from this equation that the larger the value of ω, the greater the focal length ƒ of lens 8. The aperture number ω₀ of the lens is fixed by the angle θ of the beam 7 at the output of conduit 9.
ƒ₀=ƒ/φ
where ƒ is the focal length of the lens, and φ is the input lens pupil.

The greater the angle θ of the beam at the output of conduit 9, the greater the pupil of lens 8 must be to avoid losses.

An example of a laser illuminator with divergence of 1.5×2° is presented below. The laser diode matrix has a peak power of 1 kW in the near infrared, an emitting surface dimension of 9.8×1.4 mm, and a respective divergence of θe||=10° and θeΨ=40°. The light conduit used is made of BK7 glass polished on all its faces with no dielectric coating. The dimensions of the input surface are 2×10 mm and the dimensions of the output surface are 2.26=mm which correspond to a ratio of 4:3. the total length of the conduit is L=100 mm. The beam angle 7 at the conduit output is θsΨ=40° and θs||=62°. θe|| denotes θ_{incident} according to the slow X axis and θs|| denotes θₑₓᵢₜ according to the slow Y axis. The collimation lens used has a focal length ƒ=75 mm and an aperture number ƒₒ=0.86 .

The efficiency of this laser illuminator, calculated as the ratio between the incident power on the target to be illuminated and the emission power of matrix 3 of diodes 4 is equal to η=63.7%. This number is a good value for processing of semiconductor laser beams. The performance can be enhanced still further by using antireflection coatings on the input and output faces of the light conduit.

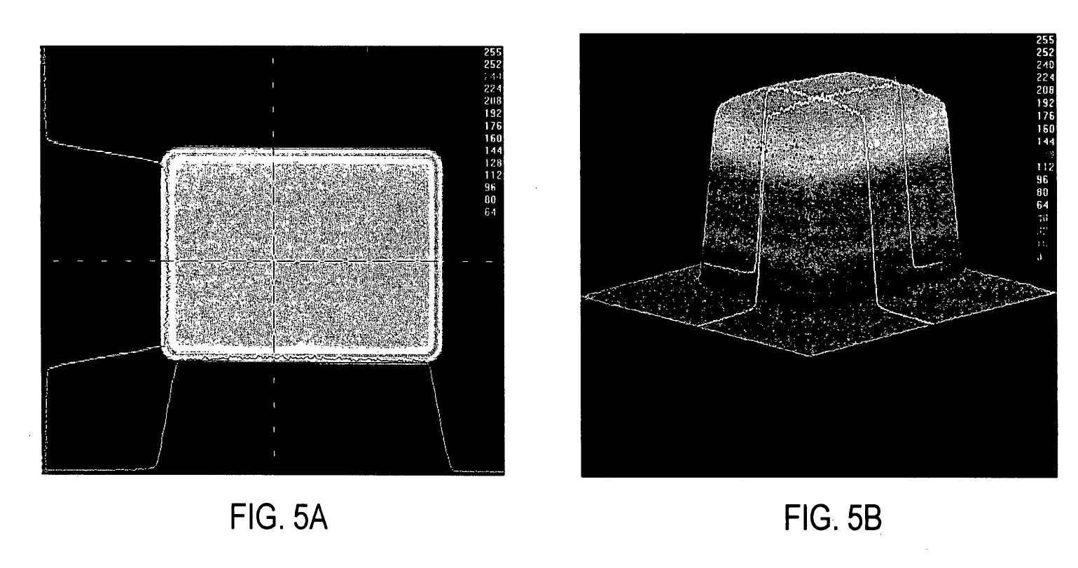

FIGS. 5a and 5b show the lighting quality at the target. They represent the intensity profile of the beam 7 leaving the output surface 12 of the light conduit 9. It can be seen that the edges are very distinct and the homogeneity is excellent.

This type of laser illuminator is simple and inexpensive to manufacture; the adjustments are limited, and do not require high precision.

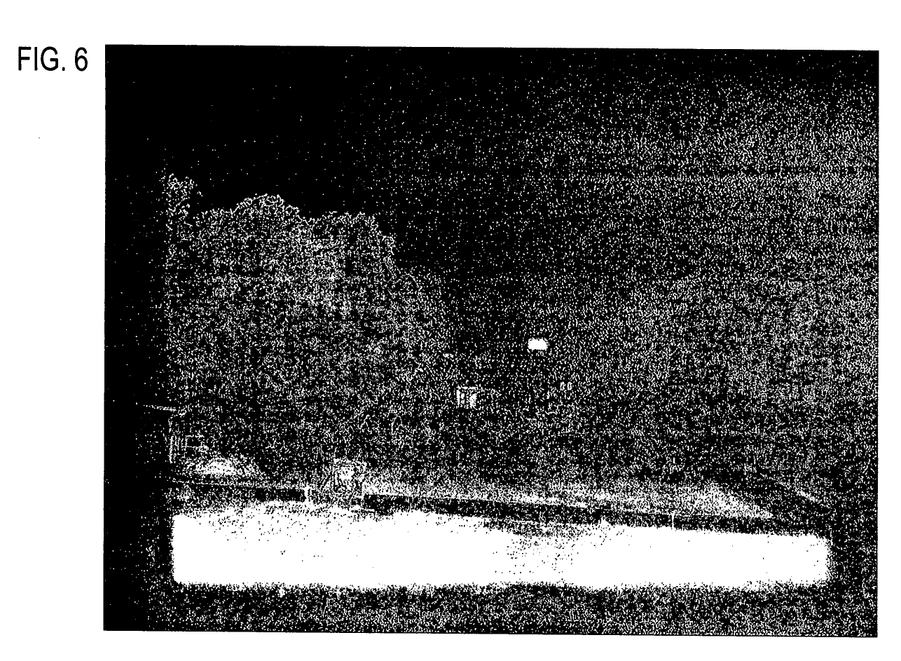

This laser illuminator has been combined with an imaging system comprised of a CCD camera with a chip length to width ratio of 4:3 and an objective with a variable focal length. The picture in FIG. 6 is an example of a nighttime recording of a scene containing objects at a distance of 1000 meters. In this example we see the shape of the rectangular illumination superimposed on the field of view of the camera. This application example shows that an illuminator according to the invention is particularly suited for scene lighting applications. Moreover, it has good energy efficiency as well as very good beam quality.

Numerous modifications may be made to the embodiment described without departing from the framework of the invention. Thus, the matrix may have different diodes able to transmit at different wavelengths. Also, the light conduit can be hollow and have internal reflecting surfaces or a reflecting coating at the wavelengths of the emitters on its internal or external surfaces. In addition, the first and second lateral surfaces can have an angle α with the axis of symmetry S of the prism as in the above example, and the third and fourth, an angle β with the axis of symmetry S, this angle β preferably being less than 10°.

1-9. (canceled)

10. A long-range laser illuminator including a matrix of high-brightness infrared emitters, each emitter able to emit a first beam, and means for processing beams coming from the emitters disposed opposite and in a vicinity of the matrix and for assembling the first beams into a second unique, homogenous beam, wherein said means comprises a prism including a planar input face disposed opposite said emitter matrix and a planar output face, the planar output face being disposed opposite a collimation lens.

11. The illuminator according to claim 1, wherein said means including an axis of symmetry and are delimited by a first surface disposed opposite and in the vicinity of the matrix, a second surface from which a second beam exits, and four lateral surfaces connecting said first and second surfaces, and wherein said lateral surfaces form an angle a of less than 15° with the axis of symmetry.

12. The illuminator according to claim 1, wherein the beams coming from the emitters are divergent along a fast axis and a slow axis, the fast axis and slow axis being perpendicular to axes of said beams, and in that the lateral surfaces that are able to reflect the beams along the slow axis form an angle a with an axis Z perpendicular to the fast and slow axes such that, over an entire length of the prism, the angle of incidence of said first beams, along the slow axis relative to the perpendicular to said lateral surfaces, is greater than a total reflection limit angle.

13. The illuminator according to claim 1, wherein the emitters of the matrix comprises laser diodes.

14. The illuminator according to claim 1, wherein said means for processing the first beams are made of glass or PLEXIGLAS.

15. The illuminator according to claim 2, wherein said first surface is coated with an antireflection coating.

16. The illuminator according to claim 1, wherein said means are hollow and their faces are reflective.

17. The illuminator according to claim 1, wherein a width-to-height ratio of an output planar face of the prism is approximately 4:3.

18. The illuminator according to claim 3, wherein the angle α is less than 15°.

19. The illuminator according to claim 2, wherein said means are hollow and their faces are reflective.

20. The illuminator according to claim 3, wherein said means are hollow and their faces are reflective.

21. The illuminator according to claim 4, wherein said means are hollow and their faces are reflective.

22. The illuminator according to claim 5, wherein said means are hollow and their faces are reflective.

23. The illuminator according to claim 6, wherein said means are hollow and their faces are reflective.

24. The illuminator according to claim 2, wherein a width-to-height ratio of an output planar face of the prism is approximately 4:3.

25. The illuminator according to claim 3, wherein a width-to-height ratio of the planar output face of the prism is approximately 4:3.

26. The illuminator according to claim 4, wherein a width-to-height ratio of an output planar face of the prism is approximately 4:3.

27. The illuminator according to claim 5, wherein a width-to-height ratio of an output planar face of the prism is approximately 4:3.

28. The illuminator according to claim 6, wherein a width-to-height ratio of an output planar face of the prism is approximately 4:3.

29. The illuminator according to claim 7, wherein a width-to-height ratio of an output planar face of the prism is approximately 4:3.
